(19) United States
(12) Patent Application Publication
(10) Pub. No.: US 2025/0349133 A1
(43) Pub. Date: Nov. 13, 2025

(54) DETERMINING DEVICE

(71) Applicants: TOYOTA JIDOSHA KABUSHIKI KAISHA, Toyota-shi Aichi-ken (JP); DENSO CORPORATION, Kariya-city Aichi-pref (JP)

(72) Inventors: Kenichiroh Hara, Yokohama-shi Kanagawa-ken (JP); Yutaro Tsugawa, Edogawa-ku Tokyo-to (JP); Hiromi Nemoto, Shinagawa-ku Tokyo-to (JP); Jiro Fujino, Nerima-ku Tokyo-to (JP); Mamoru Sakura, Koto-ku Tokyo-to (JP)

(73) Assignees: TOYOTA JIDOSHA KABUSHIKI KAISHA, Toyota-shi Aichi-ken (JP); DENSO CORPORATION, Kariya-city Aichi-pref (JP)

(21) Appl. No.: 19/198,171

(22) Filed: May 5, 2025

(30) Foreign Application Priority Data
May 10, 2024 (JP) 2024-077548

(51) Int. Cl. G06V 20/59; G06V 10/75; G06V 40/18

(52) U.S. Cl. CPC G06V 20/597; G06V 10/75; G06V 40/18

(57) ABSTRACT

A determining device has a processor configured to determine that a driver has dozed off when degree of eye opening of a left eye and degree of eye opening of a right eye of the driver are at or below a reference degree of eye opening and an absolute value of difference between the degree of eye opening of the left eye and the degree of eye opening of the right eye does not exceed a reference difference or determine that the driver has not dozed off when the degree of eye opening of the left eye and the degree of eye opening of the right eye are at or below the reference degree and the absolute value of the difference between the degree of eye opening of the left eye and the degree of eye opening of the right eye exceeds a reference difference during a determining period.

### CROSS-REFERENCE TO RELATED APPLICATIONS

This application claims priority to Japanese Patent Application No. 2024-077548 filed May 10, 2024, the entire contents of which are herein incorporated by reference.

### FIELD

The present disclosure relates to a determining device.

### BACKGROUND

A monitoring device mounted in vehicles has conventionally been used to monitor a driver state. For example, a monitoring device may monitor whether a driver has or has not dozed off.

The monitoring device determines whether the driver has dozed off by detecting the degree of eye opening based on an image of the driver's face. When the monitoring device has detected that a state in which the degree of eye opening is low (a state of closed eyes) has continued for a predetermined time period, it is determined that the driver has dozed off, and the driver is notified with a warning.

When the sun is present in the traveling direction of the vehicle, this creates a condition of sunlight glare in the driver's face, which lowers the degree of eye opening of the driver. It may therefore be erroneously determined that the driver has dozed off.

Japanese Unexamined Patent Publication No. 2006-251926, for example, discloses a technique for acquiring the light quantity surrounding the right eye and left eye, and determining that direct light is striking the eyes of the driver if the light quantity on both eyes is at or above a set value and the vertical width of the eyes is below a threshold.

### SUMMARY

If the driver has in fact dozed off, however, it may not always be possible to detect that the driver has dozed off by the technique disclosed in Japanese Unexamined Patent Publication No. 2006-251926.

It is an object of the present disclosure to provide a determining device that can determine when a driver has dozed off, in a manner that avoids erroneously determining that the driver has dozed off when sunlight glare is striking the driver's face.
(1) According to one embodiment, the present disclosure provides a determining device. The determining device has a processor configured to determine whether degree of eye opening of a left eye and degree of eye opening of a right eye of a driver is at or below a reference degree of eye opening, determine whether an absolute value of difference between the degree of eye opening of the left eye and the degree of eye opening of the right eye of the driver exceeds a reference difference during a determining period, and determine that the driver has dozed off when it has been determined that the degree of eye opening of the left eye and the degree of eye opening of the right eye of the driver are at or below the reference degree of eye opening and it has been determined that the absolute value of the difference between the degree of eye opening of the left eye and the degree of eye opening of the right eye of the driver does not exceed the reference difference, or determine that the driver has not dozed off when it has been determined that the degree of eye opening of the left eye and the degree of eye opening of the right eye of the driver are at or below the reference degree of eye opening and it has been determined that the absolute value of the difference between the degree of eye opening of the left eye and the degree of eye opening of the right eye of the driver exceeds the reference difference during the determining period.
(2) In the determining device of embodiment (1), the processor is further configured to detect a number of changes in the size of the absolute value of the difference between the degree of eye opening of the left eye and the degree of eye opening of the right eye of the driver during the determining period, determine whether or not the detected number of changes exceeds a reference number, and determine that the driver has not dozed off when it has been determined that the degree of eye opening of the left eye and the degree of eye opening of the right eye of the driver are at or below the reference degree of eye opening, it has been determined that the absolute value of the difference between the degree of eye opening of the left eye and the degree of eye opening of the right eye of the driver exceeds the reference difference during the determining period, and it has been determined that the number of changes exceeds the reference number.
(3) In the determining device of embodiment (1) or (2), the processor is further configured to determine that the driver has not dozed off when it has been determined that the absolute value of the difference between the degree of eye opening of the left eye and the degree of eye opening of the right eye of the driver exceeds the reference difference during the determining period, within a reference time period from the time at which it has been determined that the driver has not dozed off.
(4) In the determining device of any of embodiments (1) to (3), the processor is further configured to determine whether brightness of a face of the driver exceeds a first reference brightness, and determine that the driver has not dozed off when it has been determined that the degree of eye opening of the left eye and the degree of eye opening of the right eye of the driver are at or below the reference degree of eye opening, it has been determined that the absolute value of the difference between the degree of eye opening of the left eye and the degree of eye opening of the right eye of the driver exceeds the reference difference during the determining period, and it has been determined that the brightness of the face of the driver exceeds the first reference brightness.
(5) In the determining device of any of embodiments (1) to (4), the processor is further configured to determine whether brightness of a face of the driver exceeds a second reference brightness, switch to a smaller reference difference when it has been determined that the brightness of the face of the driver exceeds the second reference brightness, and use the switched reference difference to determine whether the absolute value of the difference between the degree of eye opening of the left eye and the degree of eye opening of the right eye of the driver exceeds the reference difference during the determining period.

The determining device of the disclosure can determine when a driver has dozed off, in a manner that avoids erroneously determining that the driver has dozed off when sunlight glare is striking the driver's face.

The object and advantages of the present disclosure will be realized and attained by the elements and combinations particularly specified in the claims. It is to be understood that both the foregoing general description and the following detailed description are exemplary and explanatory and are not restrictive of the present disclosure, as claimed.

### BRIEF DESCRIPTION OF DRAWINGS

FIG. 1A is a diagram illustrating operation of the monitoring device of a first embodiment in overview, and showing the interior compartment.

FIG. 1B is a diagram illustrating operation of the monitoring device of the first embodiment in overview, and showing a graph representing change in the degree of eye opening of the left eye.

FIG. 1C is a diagram illustrating operation of the monitoring device of the first embodiment in overview, and showing a graph representing change in the degree of eye opening of the right eye.

FIG. 1D is a diagram illustrating operation of the monitoring device of the first embodiment in overview, and showing a graph representing change in the absolute value of the difference in the degree of eye opening.

FIG. 2 is a general schematic drawing of a vehicle in which the monitoring device of the first embodiment is mounted.

FIG. 3 is an example of an operation flow chart for monitoring processing by the monitoring device of the first embodiment.

FIG. 4 is an example of an operation flow chart for monitoring processing by the monitoring device of the second embodiment.

FIG. 5 is an example of an operation flow chart for monitoring processing by the monitoring device of the third embodiment.

FIG. 6 is an example of an operation flow chart for monitoring processing by the monitoring device of the fourth embodiment.

### DESCRIPTION OF EMBODIMENTS

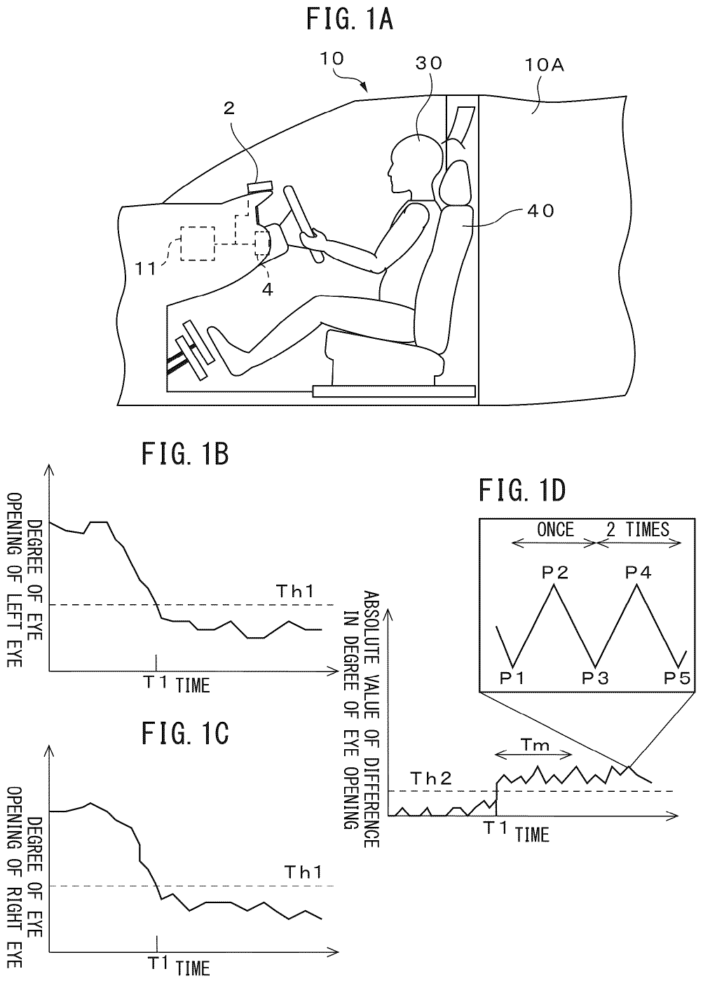

FIG. 1A and FIG. 1D are diagrams illustrating operation of a monitoring device of the first embodiment in overview. FIG. 1A shows an interior compartment of a vehicle 10, FIG. 1B shows change in the degree of eye opening of the left eye, FIG. 1C shows change in the degree of eye opening of the right eye, and FIG. 1D shows change in the absolute value of the difference in the degree of eye opening.

The vehicle 10 has a monitoring device 11, as shown in FIG. 1A. The driver 30 sits in a driving seat 40 in the cabin 10A of the vehicle 10. A monitoring camera 2 is disposed on the dashboard, for example.

The monitoring device 11 monitors the driver 30, based on monitor images acquired by the monitoring camera 2. The monitoring device 11 is an example of the determining device. The vehicle 10 may also be a self-driving vehicle.

The monitoring camera 2 is able to acquire images representing the face of the driver 30. The monitoring device 11 detects the degree of eye opening of the left eye and the degree of eye opening of the right eye of the driver 30 based on monitor images acquired by the monitoring camera 2.

The monitoring device 11 determines whether or not the driver 30 has dozed off, based on the degree of eye opening of the left eye and the degree of eye opening of the right eye of the driver 30, and the absolute value of the difference between the degree of eye opening of the left eye and the degree of eye opening of the right eye of the driver 30. When it has been determined that the driver 30 has dozed off, the monitoring device 11 gives the driver 30 a notification warning via a user interface (UI) 4.

When the sun is present in the traveling direction of the vehicle 10, this creates a condition of sunlight glare in the face of the driver 30, thus causing the driver 30 to squint the eyes. It may therefore be erroneously determined that the driver 30 has dozed off.

In some embodiments, in order to prevent erroneous determination that the driver 30 has dozed off it is desirable to be able to accurately determine whether the driver 30 is facing glare or has dozed off.

The present inventors have investigated drivers that are facing glare. As a result, the present inventors have found that a driver who is facing glare squints the eyes but still attempts to look forward, and therefore a difference exists between the degree of eye opening of the left and right eyes for a driver who is facing glare. When not facing glare, the driver has almost no difference in the degree of eye opening between the left and right eyes.

Therefore, when it has been determined that the eyes of the driver 30 are closed, the monitoring device 11 determines whether or not the driver 30 has dozed off based on the absolute value of the difference between the degree of eye opening of the left eye and the degree of eye opening of the right eye of the driver 30.

When it has been determined that the degree of eye opening of the driver 30 is at or below a reference degree of eye opening, the monitoring device 11 detects the absolute value in the difference between the degree of eye opening of the left eye and the degree of eye opening of the right eye of the driver 30. When it has been determined that the absolute value of the difference between the degree of eye opening of the left eye and the degree of eye opening of the right eye of the driver 30 exceeds a reference difference during a predetermined difference determining period, the monitoring device 11 determines that the driver 30 has not dozed off.

As shown in FIG. 1B and FIG. 1C, the driver 30 is facing glare, and therefore the degree of eye opening of the left eye of the driver 30 is at or below the reference degree of eye opening Th1 at time T1, and the degree of eye opening of the right eye of the driver 30 is also at or below the reference degree of eye opening Th1 at time T1. As shown in FIG. 1D, the absolute value in the difference between the degree of eye opening of the left eye and the degree of eye opening of the right eye of the driver 30 exceeds the reference difference Th2 during the difference determining period Tm.

Since the driver 30 who is driving squints the left and right eyes due to the glare but still attempts to look forward, the degree of eye opening between the left and right eyes is different.

When the absolute value in the difference between the degree of eye opening of the left eye and the degree of eye opening of the right eye of the driver 30 exceeds the reference difference during the difference determining period, even though it has been determined that the eyes of the driver 30 are closed, the driver 30 is estimated to be facing glare. By examining the absolute value in the difference between the degree of eye opening of the left eye and the degree of eye opening of the right eye of the driver 30, it is possible to prevent erroneously determining that the driver 30 who is facing glare has dozed off.

When it has been determined that degree of eye opening of the driver 30 is at or below the reference degree of eye opening and that the absolute value of the difference between the degree of eye opening of the left eye and the degree of eye opening of the right eye of the driver does not exceed the reference difference during the difference determining period Tm, the monitoring device 11 determines that the driver 30 has dozed off.

When it has been determined that the driver 30 has dozed off, the monitoring device 11 gives the driver 30 a notification warning via the UI 4, to increase the degree of participation in driving.

As mentioned above, the monitoring device 11 of the embodiment can determine when a driver 30 has dozed off, in a manner that avoids erroneously determining that the driver 30 has dozed off when sunlight glare is striking the face of the driver 30.

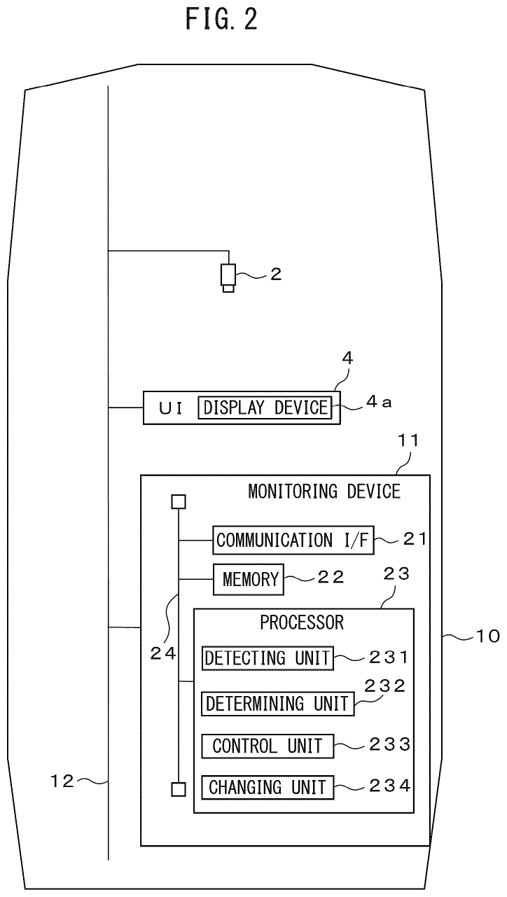

FIG. 2 is a general schematic drawing of a vehicle 10 in which the monitoring device 11 of the embodiment is mounted. The vehicle 10 has a monitoring camera 2, a user interface (UI) 4 and a monitoring device 11 etc.

The monitoring camera 2, UI 4 and monitoring device 11 are connected in a communicable manner via an in-vehicle network 12 conforming to the Controller Area Network standard.

The monitoring camera 2 is disposed inside the cabin 10A in a manner allowing it to acquire monitor images including the face of the driver 30 driving the vehicle 10. The monitoring camera 2 is an example of an image acquisition unit. For example, the monitoring camera 2 is disposed so as to allow it to acquire images near the driving seat 40. The monitoring camera 2 is disposed on the dashboard, for example, as shown in FIG. 1.

For example, the monitoring camera 2 acquires monitor images at a monitor image acquisition time having a predetermined cycle. Each time a monitor image is acquired, the monitoring camera 2 outputs the monitor image and the image acquisition time to the monitoring device 11 via the in-vehicle network 12. The predetermined cycle may be 0.1 to 0.5 seconds, for example.

The monitoring camera 2 has a 2D detector composed of an array of photoelectric conversion elements with infrared sensitivity, such as a CCD or C-MOS, and an imaging optical system that forms an image of the photographed region on the 2D detector. In some embodiments, the monitoring camera 2 has a lighting device in addition to the 2D detector. The lighting device is a pair of near-infrared LEDs (light emitting diodes) situated on either side of the imaging optical system, for example. Illuminating the driver 30 with near-infrared light allows the face of the driver 30 to be imaged without causing discomfort for the driver 30 even during low-illuminance periods such as nighttime.

The UI 4 is an example of the notification unit. The UI 4, controlled by the monitoring device 11, notifies the driver 30 with a warning, for example. The UI 4 has a display device 4a such as a liquid crystal display or touch panel, for display of the warning. The UI 4 may also have an acoustic output device (not shown) to notify the driver 30 of the warning. The UI 4 also has a touch panel or operating button, for example, as an input device for inputting operation information from the driver 30 to the vehicle 10. The UI 4 outputs the input operation information to the monitoring device 11 via the in-vehicle network 12.

The monitoring device 11 carries out detection processing, determination processing, control processing and change processing. For this purpose, the monitoring device 11 has a communication interface (IF) 21, a memory 22 and a processor 23. The communication interface 21, memory 22 and processor 23 are connected via signal wires 24. The communication interface 21 has an interface circuit to connect the monitoring device 11 with the in-vehicle network 12.

The memory 22 is an example of a storage unit, and it has a volatile semiconductor memory and a non-volatile semiconductor memory, for example. The memory 22 stores an application computer program and various data to be used for information processing carried out by the processor 23 of each device. The memory 22 also stores monitor images input from the monitoring camera 2, in association with the image acquisition times.

All or some of the functions of the monitoring device 11 are functional modules driven by a computer program operating on the processor 23, for example. The processor 23 has a detecting unit 231, a determining unit 232, a control unit 233 and a changing unit 234.

Alternatively, the functional module of the processor 23 may be a specialized computing circuit in the processor 23.

The processor 23 has one or more CPUs (Central Processing Units) and their peripheral circuits. The processor 23 may also have other computing circuits such as a logical operation unit, numerical calculation unit or graphics processing unit. The driver monitoring device 11 is an electronic control unit (ECU), for example.

The detecting unit 231 calculates the degree of eye opening of the driver 30 based on multiple monitor images, at an eye opening degree detection time having a predetermined cycle. The cycle may be from 0.1 to 5 seconds, for example.

The detecting unit 231 has a classifier trained to detect eye regions by input of monitor images. The classifier inputs monitor images and detects the eye regions within the monitor images.

The classifier is a deep neural network (DNN) having multiple layers connected in series from the input end to the output end, for example. Images including the eyes are previously input into the DNN as teacher data for learning, whereby the DNN is able to function as a classifier to detect eye regions. A machine learning model such as a support vector machine or random forest may also be used as the classifier.

The detecting unit 231 also calculates the distance from the monitoring camera 2 to the face of the driver 30. For example, the detecting unit 231 refers to the relationship between distances and standard sizes of human faces represented in images, and calculates the distance between the monitoring camera 2 and the face of the driver 30 based on the magnitude of the face of the driver 30 represented in the monitor image. The region of the face of the driver 30 in the monitor image is detected using a classifier that has been trained to detect face regions.

The detecting unit 231 calculates the degree of eye opening based on the distance from the monitoring camera 2 to the face of the driver 30 and the number of pixels between the upper eyelid and lower eyelid in the monitor image. For example, the detecting unit 231 may calculate the maximum number of pixels between the upper eyelid and lower eyelid. The degree of eye opening is represented in mm units, for example. The detecting unit 231 relays the degree of eye opening for the right eye and left eye of the driver to the determining unit 232. As shown in FIG. 1B and FIG. 1C, the determining unit 232 obtains a time series change for the degree of eye opening of the left eye and the degree of eye opening of the right eye of the driver 30.

From the viewpoint of accurately detecting the degree of eye opening, the resolution of the monitor images acquired by the monitoring camera 2 may be increased, or the monitor images may be acquired in a manner such that the parts of the left and right eyes of the driver 30 are magnified.

After the detecting unit 231 calculates the absolute value in the difference between the degree of eye opening of the left eye and the degree of eye opening of the right eye of the driver 30, the detecting unit 231 notifies the determining unit 232 of the absolute value. As shown in FIG. 1D, the detecting unit 231 and determining unit 232 obtain a time series change for the absolute value in the difference between the degree of eye opening of the left eye and the degree of eye opening of the right eye of the driver 30.

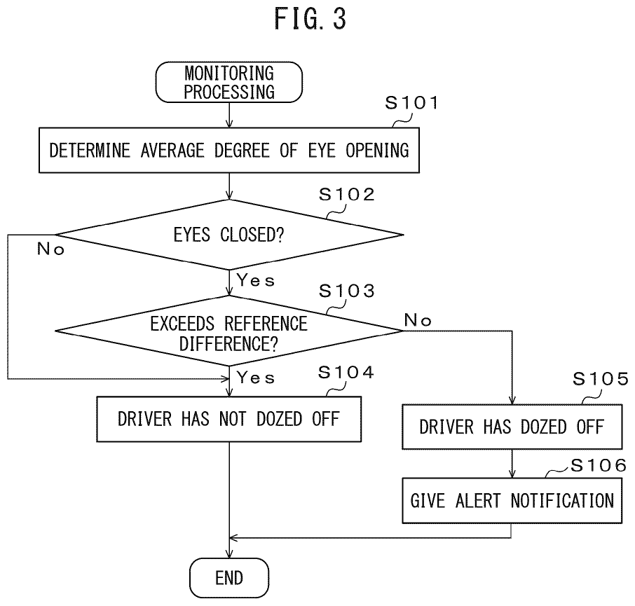

FIG. 3 is an example of an operation flow chart for monitoring processing by the monitoring device 11 of the embodiment. Monitoring processing by the monitoring device 11 will be described below with reference to FIG. 3. The monitoring device 11 carries out monitoring processing according to the operation flow chart shown in FIG. 3, at a monitoring time with a predetermined cycle.

First, the determining unit 232 calculates the average value for the degree of eye opening of the driver 30 (step S101). For example, the determining unit 232 calculates the average degree of eye opening obtained within the most recent fixed time period for both the left and right eyes of the driver 30. The most recent fixed time period may be 10 to 30 seconds.

The determining unit 232 then determines whether or not the eyes of the driver 30 are closed based on the degree of eye opening of the driver 30 (step S102). For example, when the average degrees of eye opening of the left eye and eye opening of the right eye of the driver 30 are both at or below the reference degree of eye opening, the determining unit 232 determines that the eyes of the driver 30 are closed. The reference degree of eye opening may be 3 mm, for example. The degree of eye opening of a human is usually in the range of 10 mm to 30 mm.

When the average degree of eye opening for either one of the left and right eyes of the driver 30 is not at or below the reference degree of eye opening, the determining unit 232 determines that the eyes of the driver 30 are not closed.

When it has been determined that the eyes of the driver 30 are closed (step S102—Yes), the determining unit 232 determines whether or not the absolute value in the difference between the degree of eye opening of the left eye and the degree of eye opening of the right eye of the driver 30 exceeds the reference difference during the difference determining period (step S103).

The reference difference may be 0.5 mm, for example. When not facing glare, the absolute value in the difference between the degree of eye opening of the left eye and the degree of eye opening of the right eye of the driver 30 is about 0.1 mm. Since the precision for determining the degree of eye opening is about 0.1 mm, a reference difference of 0.5 mm allows the degree of eye opening of the driver 30 when facing glare to be determined. The difference determining period may be 3 to 5 seconds, for example. The difference determining period is an example of the determining period.

For example, the difference determining period may start from the time at which it has been determined that the eyes of the driver 30 are closed. The difference determining period may also include the time at which it has been determined that the eyes of the driver 30 are closed.

When the absolute value of the difference in the degree of eye opening exceeds the reference difference (step S103—Yes) or it has been determined that the eyes of the driver 30 are not closed (step S102—No), the determining unit 232 determines that the driver 30 has not dozed off (step S104), and the series of processing steps is complete.

When the absolute value of the difference in the degree of eye opening does not exceed the reference difference (step S103—No), on the other hand, the determining unit 232 determines that the driver 30 has dozed off (step S105).

The processing to determine whether or not the eyes are closed may also be carried out between step S103 and step S105. After the determining unit 232 has determined that the eyes of the driver 30 are closed during a predetermined time period (such as 3 to 5 seconds), it may proceed to step S105. When it has been determined during this period that the eyes of the driver are not closed, the series of processing steps is complete.

The control unit 233 then gives the driver 30 a notification warning via the UI 4 (step S106), and the series of processing steps is complete. For example, the control unit 233 outputs a loud alarm while displaying a warning on the display device 4a, via the UI 4. The monitoring device 11 thus increases the degree of participation of the driver 30 in driving.

Operation of the monitoring device 11 will now be explained with reference to FIG. 1B to FIG. 1D. The ordinate in FIG. 1B represents the degree of eye opening of the left eye, and the abscissa represents time. The ordinate in FIG. 1C represents the degree of eye opening of the right eye, and the abscissa represents time. The ordinate in FIG. 1D represents the absolute value of the difference in the degree of eye opening, and the abscissa represents time.

As shown in FIG. 1B and FIG. 1C, the degree of eye opening of the left eye of the driver who is facing glare is at or below the reference degree of eye opening Th1 at time T1, and the degree of eye opening of the right eye of the driver 30 is also at or below the reference degree of eye opening Th1 at time T1.

As shown in FIG. 1D, the absolute value in the difference between the degree of eye opening of the left eye and the degree of eye opening of the right eye of the driver 30 exceeds the reference difference Th2 during the difference determining period Tm. As shown in FIG. 1B and

FIG. 1C, the degree of eye opening of the left eye and the degree of eye opening of the right eye of the driver 30 is also at or below the reference degree of eye opening Th1 during the difference determining period Tm.

The driver 30 who is driving squints the left and right eyes due to the glare, but still attempts to look forward. Since the driver 30 opens the dominant eye more than the non-dominant eye, a difference is produced between the degree of eye opening of the left and right eyes. When facing glare, therefore, a difference is produced between the degree of eye opening of the left eye and the degree of eye opening of the right eye of the driver 30.

When the absolute value in the difference between the degree of eye opening of the left eye and the degree of eye opening of the right eye of the driver 30 exceeds the reference difference during the difference determining period, even though it has been determined that the eyes of the driver 30 are closed, the driver 30 is estimated to be facing glare. By examining the absolute value in the difference between the degree of eye opening of the left eye and the degree of eye opening of the right eye of the driver 30, it is possible to prevent erroneously determining that the driver 30 who is facing glare has dozed off.

With the monitoring device of the embodiment described in detail above, it is possible to determine that a driver has dozed off, in a manner that avoids erroneously determining that the driver has dozed off when sunlight glare is striking the driver's face.

A modified example of the monitoring device 11 of this embodiment will now be described. For this modified example, the reference difference changes based on the brightness of the face of the driver 30.

The detecting unit 231 detects the brightness of the face of the driver 30 based on monitor images. The detecting unit 231 has a classifier trained to detect facial regions by input of monitor images. The classifier inputs monitor images and detects the facial regions within the monitor images.

The detecting unit 231 calculates the average value for the brightness of pixels in the facial regions of the monitor images during a predetermined brightness determining period. When the monitor images are represented as gray scale, the average value for the brightness is represented as a value between 0 and 255. When the monitor images are color images, the average value for the brightness can be calculated as the average value for the red pixel brightness, the green pixel brightness and the blue pixel brightness. The average value for the brightness can also be calculated based on the average value for the brightness of the pixels of the monitor images, and the parameter relating to exposure time, such as the shutter speed of the monitoring camera 2. The brightness determining period may be 1 to 3 seconds, for example. The detecting unit 231 calculates the average brightness of pixels in the facial region of

the monitor image, for each monitor image acquired during the brightness determining period, to determine the monitor image brightness. The detecting unit 231 also calculates the average brightness for multiple monitor images acquired during the brightness determining period.

The detecting unit 231 notifies the determining unit 232 of the average brightness of the monitor images acquired during the brightness determining period, as the average brightness for pixels in the facial regions of the monitor images. The determining unit 232 uses the average brightness of pixels in the facial region of the monitor image during the brightness determining period as the brightness of the face of the driver 30.

The monitoring device 11 carries out change processing at a change time having a predetermined cycle. The determining unit 232 determines whether or not the average brightness for pixels in the facial region of the monitor images exceeds the predetermined reference brightness during the brightness determining period. The reference brightness may be 200 to 230, for example.

When the brightness of the face of the driver 30 exceeds the predetermined reference brightness, it is estimated that the driver 30 is facing glare. In some embodiments, the reference brightness is decided so that the brightness of the face can be determined when the driver 30 is facing glare. The reference brightness is an example of the second reference brightness.

When the brightness of the face of the driver 30 exceeds the reference brightness, the changing unit 234 switches to a smaller reference difference. For example, the changing unit 234 switches the reference difference from 0.5 mm to 0.3 mm.

When it has been determined that the driver 30 is facing glare, the reference difference is switched so as to more easily detect difference between the degree of eye opening of the left eye and the degree of eye opening of the right eye of the driver 30.

When the brightness of the face of the driver 30 does not exceed the reference brightness, on the other hand, the changing unit 234 leaves the reference difference at the initial value (0.5 mm).

The determining unit 232 uses the reference difference switched by the changing unit 234 to determine whether or not the absolute value in the difference between the degree of eye opening of the left eye and the degree of eye opening of the right eye of the driver 30, as detected by the detecting unit 231, exceeds the reference difference.

With the monitoring device of the embodiment described in detail above it is possible to more accurately determine whether the driver 30 is facing glare.

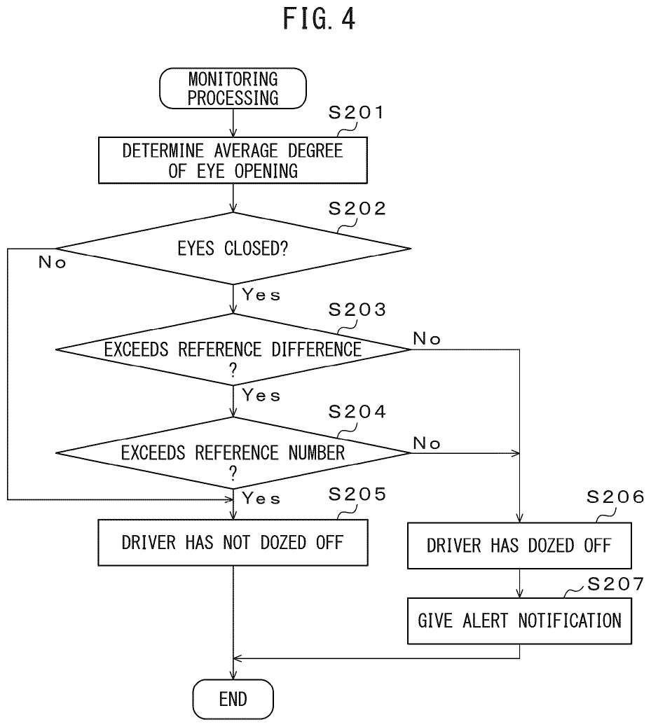

Monitoring devices of the second embodiment to fourth embodiment disclosed herein will now be explained with reference to FIG. 4 to FIG. 6. The explanation for the monitoring device of the first embodiment applies for any aspects of the monitoring devices of these embodiments that are not explained here.

FIG. 4 is an example of an operation flow chart for monitoring processing by the monitoring device 11 of the second embodiment. This embodiment differs from the first embodiment described above in that the processing of step S204 is added. The processing for steps S201 to S203 and S205 to S207 are the same as in steps S101 to S106 described above.

For this embodiment, the detecting unit 231 detects the number of changes in the size of the absolute value in the difference between the degree of eye opening of the left eye and the degree of eye opening of the right eye of the driver 30 during the difference determining period. The detecting unit 231 detects the maximum value and minimum value for the absolute value in the difference between the degrees of eye opening. The detecting unit 231 counts, as one “change”, a change of increase in the absolute value of the difference in the degree of eye opening from the minimum value to the maximum value, and then decrease to the minimum value, with the passage of time. The detecting unit 231 notifies the determining unit 232 of the number of changes during the difference determining period.

In the example shown in FIG. 1D, the absolute value of the difference in the degree of eye opening is first the minimum value P1, then the maximum value P2, subsequently the minimum value P3 and then the maximum value P4, finally returning to the minimum value P5.

The change from minimum value P1 to minimum value P3 and the change from minimum value P3 to minimum value P5 are each counted as one change. The method of detecting change in the absolute value of the difference in the degree of eye opening is not limited to this method, however. For example, the detecting unit 231 may count, as one “change”, a change of decrease in the absolute value of the difference in the degree of eye opening from the maximum value to the minimum value, and then increase to the maximum value, with the passage of time.

For this embodiment, when the absolute value of the difference in the degree of eye opening exceeds the reference difference (step S203—Yes), the determining unit 232 determines whether or not the number of changes has exceeded the reference number during the difference determining period (step S204).

The present inventors have investigated drivers that are facing glare. As a result, the present inventors have found that the degree of eye opening of the left and right eyes of a driver who is facing glare varies drastically, compared to when there is no glare.

In some embodiments, the reference number is decided so as to allow accurate determination between the number of changes in the difference in the degree of eye opening between the left and right eyes of a driver who is facing glare, and the number of changes in the difference in the degree of eye opening between the left and right eyes of a driver who is not facing glare. The reference number can be appropriately decided according to the method for detecting change in the absolute value of the difference in the degree of eye opening.

When the number of changes has exceeded the reference number (step S204—Yes), the determining unit 232 determines that the driver 30 has not dozed off (step S205), and the series of processing steps is complete.

When the number of changes does not exceed the reference number (step S204—No), on the other hand, the determining unit 232 determines that the driver 30 has dozed off (step S206). Processing then proceeds to step S207. When the number of changes does not exceed the reference number, it is possible that the driver 30 is not facing glare, and therefore in order to further ensure safety it is determined that the driver 30 has dozed off.

As explained in detail above, the monitoring device of this embodiment can more accurately determine that glare of sunlight is striking the face of the driver 30, by also determining the number of changes in the absolute value of the difference in the degree of eye opening. The monitoring device of this embodiment also exhibits the same effect as the first embodiment.

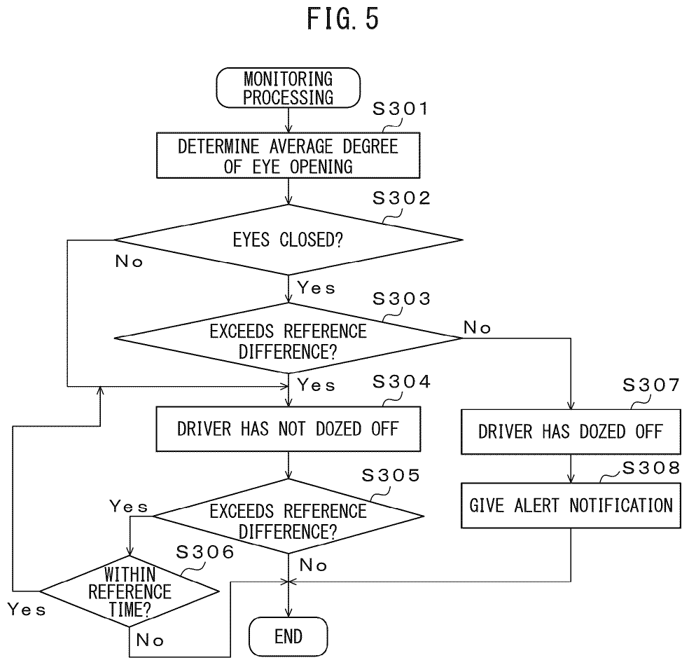

FIG. 5 is an example of an operation flow chart for monitoring processing by the monitoring device 11 of the third embodiment. This embodiment differs from the first embodiment described above in that the processing of steps S305 and S306 is added. The processing for steps S301 to S304, S307 and S308 are the same as in steps S101 to S106 described above.

When it has been determined that the driver 30 has not dozed off (step S304), the determining unit 232 determines whether or not the absolute value in the difference between the degree of eye opening of the left eye and the degree of eye opening of the right eye of the driver exceeds the reference difference during the difference determining period (step S305).

When the absolute value of the difference in the degree of eye opening exceeds the reference difference (step S305—Yes), the determining unit 232 determines whether or not it is within the reference time period from the time at which it was determined that the driver 30 has not dozed off (step S306). The determining unit 232 determines whether or not the time period during which it has been determined that the absolute value of the difference in the degree of eye opening exceeds the reference difference during the difference determining period, is within the reference time period from the time at which it was determined that the driver 30 has not dozed off. The reference time may be 3 to 10 seconds, for example.

When the time is within the reference time period (step S306—Yes), the determining unit 232 determines that the driver 30 has not dozed off (step S304). Processing then proceeds to step S305.

When the absolute value of the difference in the degree of eye opening does not exceed the reference difference (step S305—No), on the other hand, or when the time is not within the reference time period (step S306—No), the series of processing steps is complete. For this embodiment, when it has been determined that the driver 30 has not dozed off,

the driver 30 is estimated to be facing glare. For this embodiment, therefore, a state of glare on the driver 30 continues to be determined without determining a closed-eye state.

As explained in detail above, the monitoring device of this embodiment can reduce processing volume by the monitoring device. Moreover the monitoring device of this embodiment exhibits the same effect as the first embodiment.

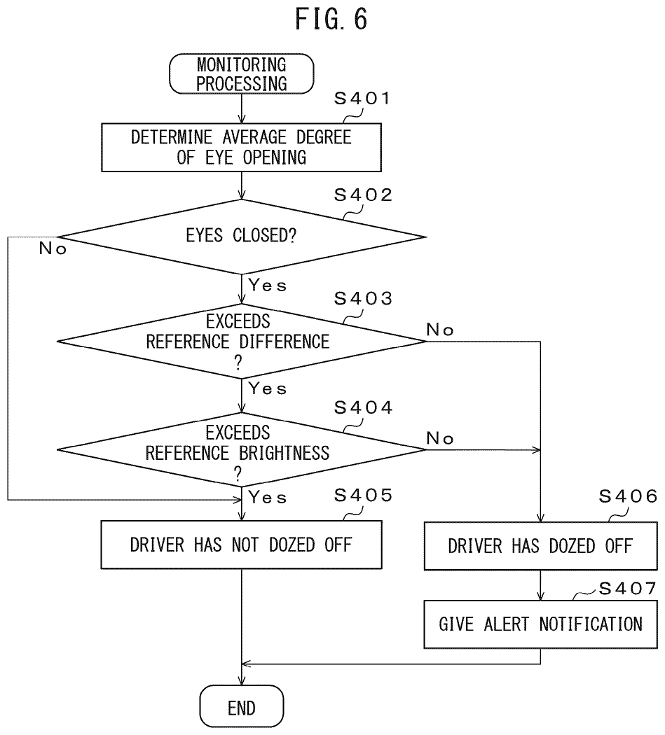

FIG. 6 is an example of an operation flow chart for monitoring processing by the monitoring device 11 of the fourth embodiment. This embodiment differs from the first embodiment described above in that the processing of step S404 is added. The processing for steps S401 to S403 and S405 to S407 are the same as in steps S101 to S106 described above.

For this embodiment, when the absolute value of the difference in the degree of eye opening exceeds the reference difference (step S403—Yes), the determining unit 232 determines whether or not the brightness of the face of the driver 30 exceeds the predetermined reference brightness (step S404).

The determining unit 232 acquires from the detecting unit 231 the average value for the brightness of pixels in the facial regions of monitor images during the brightness determining period. The determining unit 232 determines whether or not the average brightness for pixels in the facial region of the monitor images exceeds the reference brightness during the brightness determining period. The reference brightness is an example of the first reference brightness. The reference brightness may be 200 to 230, for example. The brightness determining period may be 1 to 3 seconds, for example.

When the brightness of the face of the driver 30 exceeds the reference brightness (step S404—Yes), the determining unit 232 determines that the driver 30 has not dozed off (step S405), and the series of processing steps is complete.

When the brightness of the face of the driver 30 does not exceed the reference brightness (step S404—No), on the other hand, the determining unit 232 determines that the driver 30 has dozed off (step S406). Processing then proceeds to step S407. When the brightness of the face of the driver 30 does not exceed the reference brightness, it is possible that the driver is not facing glare, and therefore in order to further ensure safety it is determined that the driver 30 has dozed off.

As explained in detail above, the monitoring device of this embodiment can more accurately detect a state of glare based on the brightness of the driver's face. The monitoring device of this embodiment also exhibits the same effect as the first embodiment.

The determining device according to the embodiment described above may incorporate appropriate modifications that are still within the gist of the present disclosure. Moreover, the technical scope of the disclosure is not limited to these embodiments, and includes the present disclosure and its equivalents as laid out in the Claims.

For example, processing for calculation of the degree of eye opening of the driver as described in the embodiments is merely an example, and is not intended to be limitative. Moreover, processing for detection of the number of changes in the absolute value of the difference between the degree of eye opening of the left eye and the degree of eye opening of the right eye of the driver for the embodiments described above is merely an example and is not intended to be limitative. Processing for detecting the brightness of the face of the driver in the aforementioned embodiment is also merely an example and is not intended to be limitative.

1. A determining device comprising:
a processor configured to
determine whether degree of eye opening of a left eye and degree of eye opening of a right eye of a driver is at or below a reference degree of eye opening,
determine whether an absolute value of difference between the degree of eye opening of the left eye and the degree of eye opening of the right eye of the driver exceeds a reference difference during a determining period, and
determine that the driver has dozed off when it has been determined that the degree of eye opening of the left eye and the degree of eye opening of the right eye of the driver are at or below the reference degree of eye opening and it has been determined that the absolute value of the difference between the degree of eye opening of the left eye and the degree of eye opening of the right eye of the driver does not exceed the reference difference, or determine that the driver has not dozed off when it has been determined that the degree of eye opening of the left eye and the degree of eye opening of the right eye of the driver are at or below the reference degree of eye opening and it has been determined that the absolute value of the difference between the degree of eye opening of the left eye and the degree of eye opening of the right eye of the driver exceeds the reference difference during the determining period.

2. The determining device according to claim 1, wherein the processor is further configured to
detect a number of changes in a size of the absolute value of the difference between the degree of eye opening of the left eye and the degree of eye opening of the right eye of the driver during the determining period,
determine whether or not the detected number of changes exceeds a reference number, and
determine that the driver has not dozed off when it has been determined that the degree of eye opening of the left eye and the degree of eye opening of the right eye of the driver are at or below the reference degree of eye opening, it has been determined that the absolute value of the difference between the degree of eye opening of the left eye and the degree of eye opening of the right eye of the driver exceeds the reference difference during the determining period, and it has been determined that the number of changes exceeds the reference number.

3. The determining device according to claim 1, wherein the processor is further configured to determine that the driver has not dozed off when it has been determined that the absolute value of the difference between the degree of eye opening of the left eye and the degree of eye opening of the right eye of the driver exceeds the reference difference during the determining period, within a reference time period from the time at which it has been determined that the driver has not dozed off.

4. The determining device according to claim 1, wherein the processor is further configured to
determine whether brightness of a face of the driver exceeds a first reference brightness, and
determine that the driver has not dozed off when it has been determined that the degree of eye opening of the left eye and the degree of eye opening of the right eye of the driver are at or below the reference degree of eye opening, it has been determined that the absolute value of the difference between the degree of eye opening of the left eye and the degree of eye opening of the right eye of the driver exceeds the reference difference during the determining period, and it has been determined that the brightness of the face of the driver exceeds the first reference brightness.

5. The determining device according to claim 1, wherein the processor is further configured to
determine whether brightness of a face of the driver exceeds a second reference brightness,
switch to a smaller reference difference when it has been determined that the brightness of the face of the driver exceeds the second reference brightness, and
use the switched reference difference to determine whether the absolute value of the difference between the degree of eye opening of the left eye and the degree of eye opening of the right eye of the driver exceeds the reference difference during the determining period.
